(19) United States
(12) Patent Application Publication
(10) Pub. No.: US 2007/0242395 A1
(43) Pub. Date: Oct. 18, 2007

(54) Methods of manipulating the relaxation rate in magnetic materials and devices for using the same

(76) Inventor: William E. Bailey, New York, NY (US)

Correspondence Address: WilmerHale/Columbia University, 399 PARK AVENUE, NEW YORK, NY, 10022, US

(21) Appl. No.: 11/253,086

(22) Filed: Oct. 17, 2005

Related U.S. Application Data
(60) Provisional application No. 60/619,566, filed on Oct. 15, 2004.

(51) Int. Cl. G11B 5/33

(52) U.S. Cl. 360/324.2

(57) ABSTRACT

In accordance with the present invention, ferromagnetic thin films of iron that have reduced relaxation rates and methods of making the same are provided. It should be noted that pure iron is a ferromagnet (i.e., has a spontaneous magnetization alignment) with the lowest intrinsic damping rate of all of the ferromagnets. The present invention provides a ferromagnetic structure comprising a substrate and a ferromagnetic thin film of iron (Fe) formed on the substrate. An element selected from the group consisting of titanium (Ti), vanadium (V), chromium (Cr), and manganese (Mn) (i.e., a lower-Z transition metal element) is alloyed with the ferromagnetic thin film of iron to reduce the relaxation rate of the ferromagnetic thin film.

### CROSS REFERENCE TO RELATED APPLICATIONS

This application claims the benefit of U.S. Provisional Patent Application No. 60/619,566, filed on Oct. 15, 2004, which is hereby incorporated by reference herein in its entirety.

### STATEMENT REGARDING FEDERALLY SPONSORED RESEARCH OR DEVELOPMENT

The government may have certain rights in the present invention pursuant to grants from the Army Research Office (ARO) Young Investigator Program (YIP), Award No. DAAD-19-02-1-0375.

### FIELD OF THE INVENTION

The present invention generally relates to methods and systems for processing thin films. More particularly, the present invention relates to the processing of ferromagnetic thin films.

### BACKGROUND OF THE INVENTION

In magnetic data storage systems, a magnetic recording head typically consists of a read element located between two highly-permeable magnetic shields. The read element is generally made from a ferromagnetic material whose resistance changes as a function of an applied magnetic field. One example of a read element is a giant magnetoresistance (GMR) read sensor. A typical GMR read sensor has a GMR spin valve, in which the GMR read sensor is a multi-layered structure formed of a nonmagnetic spacer layer positioned between a ferromagnetic pinned layer and a ferromagnetic free layer. The magnetization of the pinned layer is fixed in a predetermined direction, while the magnetization of the free layer rotates freely in response to an external magnetic field. The resistance of the GMR read sensor varies as a function of an angle formed between the magnetization direction of the free layer and the magnetization direction of the pinned layer.

When the magnetic recording head is scanned over a disc, the free layer magnetization will rotate in response to the stray fields emerging from the bits in the media, thereby producing changes in resistance. However, it should be noted that the intrinsic electrical noise of the GMR read head sensor can be exceeded by resistance noise arising from thermally-induced magnetization fluctuations (sometimes referred to herein as “mag-noise”) in the ferromagnetic free layer when the free layer volume is small enough.

As magnetic devices, such as magnetic sensors, magnetic tunneling junctions, and spin valves, are required to have nanometer dimensions and operate at high frequencies in the gigahertz (GHz) range, it is likely that mag-noise will become a limitation on the ability to decrease the size of the device and increase the frequency. For ambient temperatures, the noise power increases strongly with decreasing sample volume, V, and increasing the relaxation rate, λ. For small sensors at high frequencies, mag-noise is predicted to dominate the spectrum. It has recently been predicted that signal-to-noise ratio for these nanometer-sized, high frequency sensors will be inversely dependent on the Gilbert damping coefficient or the relaxation rate of the free layer, λ, and independent of the resistance change or the giant magnetoresistance/tunneling magnetoresistance (GMR/TMR) ratio, ΔR/R (see, e.g., N. Smith and P. Arnett, Applied Physics Letters 78, 1448 (2001)). It should be noted that the relaxation rate (λ) is derived from the Landau-Lifshitz (LL) equation shown below:

$$\frac{ⅆ M}{ⅆ t} = - {μ}_{0} \vert γ \vert ( M \times H ) - \frac{λ}{{M}_{s}^{2}} ( M \times M \times H ) ,$$

where M is the magnetization vector, H is the local magnetic field vector, Mₛ is the saturation magnetization (in A/m), μ₀ to is the permeability of free space, γ is the gyromagnetic ratio, and λ is the relaxation rate.

While materials-based techniques have been recently developed to tune the magnetization dynamics in ferromagnetic thin films, current techniques do not allow for adequate reduction of the relaxation rate, λ. Previous results have shown that both the precessional frequency and damping constant of Ni₈₁Fe₁₉ can be adjusted through introduction of rare-earth impurity atoms, but only in an increasing direction. For example, it has been proven that creating a bilayer structure having a rare-earth element-doped Ni₈₁Fe₁₉ film (e.g., Tb-doped Ni₈₁Fe₁₉) along with a conventional magnetic thin film (e.g., Ni₈₁Fe₁₉), where each layer has different damping parameters, increased the damping coefficient (for Tb dopants) and the precessional frequency (for Eu dopants). Increases in damping arise from the introduction of an impurity with a finite local orbital moment, thereby leading to a more efficient transfer of energy into lattice vibrations. Increases in precessional frequency arise from the introduction of an impurity with a stronger magnetic anisotropy, which stiffens the rotations of the magnetization against the lattice, or stronger g-factor. See, e.g., W. Bailey, P. Kabos, F. Mancoff, and S. Russek, IEEE Transactions on Magnetics 37, 1749 (2001), S. G. Reidy, L. Cheng, and W. E. Bailey, Applied Physics Letters 82, 1254 (2003), and L. Cheng, H. Song, and W. E. Bailey, IEEE Transactions on Magnetics 40, 2350 (2004). Although control and understanding of damping and the relaxation rate in magnetic materials is essential for current and future magnetoelectronic devices, little work has been done in relation to manipulating materials.

There is therefore a need in the art for a method of reducing the relaxation rate of magnetic thin films. Accordingly, it is desirable to provide materials and methods that overcome these and other deficiencies of the prior art.

### SUMMARY OF THE INVENTION

In accordance with the present invention, ferromagnetic thin films of iron that have reduced damping and methods of making the same are provided. It should be noted that pure iron is a ferromagnet (i.e., has a spontaneous magnetization alignment) with the lowest intrinsic damping rate of all of the elemental ferromagnets.

The present invention provides a ferromagnetic structure comprising a substrate and a ferromagnetic thin film of iron (Fe) formed on the substrate. An element selected from the group consisting of titanium (Ti), vanadium (V), chromium (Cr), and manganese (Mn) (i.e., lower Z transition metal elements) is alloyed with the ferromagnetic thin film of iron to reduce the damping coefficient of the ferromagnetic thin film. Alternatively, any other suitable group V (e.g., niobium, tantalum, hafnium) or group VI (e.g., chromium, molybdenum, tungsten) transition metal element or lower valence transition metal element may also be alloyed with iron to form the ferromagnetic thin film. When the alloyed element is vanadium, the ferromagnetic thin film preferably has the composition Fe₁₋ₓVₓ, where x may be between 0 and 0.99, but is preferably between 0 and about 0.33. The substrate may be a silicon substrate, a gallium arsenide substrate, a magnesium oxide substrate, or any other suitable substrate. A suitable substrate may also provide an acceptable lattice match with the iron thin film.

In accordance with one aspect of the invention, a method for reducing the damping coefficient of a thin film of iron includes: (a) providing a substrate and (b) depositing a ferromagnetic thin film on the substrate, wherein the thin film is composed of an alloy of iron having a given damping coefficient and an element selected from the group consisting of titanium (Ti), vanadium (V), chromium (Cr), and manganese (Mn), and wherein alloying the iron with the element reduces the given damping coefficient of iron. In some embodiments, the alloying element is vanadium and the thin film is deposited by cosputtering iron and vanadium onto the substrate.

Various devices, in which this ferromagnetic thin film is suitable for use, are presented. More particularly, on-chip elements (e.g., circulators, filters, etc.) in telecommunications devices (e.g., cellular telephones), magnetic spin valves, magnetic read heads, or any other suitable device may be fabricated using these ferromagnetic thin films.

Thus, there has been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and description matter in which there is illustrated preferred embodiments of the invention.

### BRIEF DESCRIPTION OF THE DRAWINGS

Various objects, features, and advantages of the present invention can be more fully appreciated with reference to the following detailed description of the invention when considered in connection with the following drawing, in which like reference numerals identify like elements.

FIG. 1 illustrates schematically, in cross-section, a ferromagnetic structure in accordance with some embodiments of the present invention.

FIG. 2 illustrates x-ray diffraction spectra of epitaxial Fe₁₋ₓVₓ (100) thin films with different concentrations of vanadium.

FIG. 3 illustrates an x-ray diffraction characterization of epitaxial Fe₁₋ₓVₓ (100) thin films with different concentrations of vanadium.

FIG. 4 illustrates graphically the relationship between the magnetic moments of a ferromagnetic structure (epitaxial MgO (100)/Fe₁₋ₓVₓ (100)) and the concentration of vanadium.

FIG. 5 illustrates graphically the relationship between the Ferromagnetic Resonance Spectroscopy (FMR) linewidth of the epitaxial Fe₁₋ₓVₓ thin films with different concentrations of vanadium and the frequency.

FIG. 6 illustrates a portion of a magnetic random access memory (MRAM) array comprising a magnetic tunnel junction (MTJ) in accordance with some embodiments of the present invention.

FIG. 7 illustrates schematically, in cross-section, a magnetic tunnel junction structure in accordance with some embodiments of the present invention.

FIG. 8 illustrates schematically, in cross-section, a spin valve structure in accordance with some embodiments of the present invention.

FIG. 9 illustrates schematically, in cross-section, a filter structure in accordance with some embodiments of the present invention.

### DETAILED DESCRIPTION OF THE PREFERRED EMBODIMENTS

In the following detailed description, numerous specific details are set forth regarding the system and method of the present invention and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

In accordance with the present invention, ferromagnetic thin films of iron that have reduced damping and methods of making the same are provided. To reduce the relaxation rate of pure iron (Fe), which undoped possesses the lowest intrinsic damping of all elemental ferromagnets, alloying elements, such as vanadium titanium, chromium, and manganese, may be added to the iron.

It should be noted that it is not obvious how the introduction of foreign species may be used to reduce the damping of a ferromagnet. A localized moment with lower damping than the host is likely to be ineffective, as the damping would tend towards that of the host. An effective impurity to reduce the damping would therefore need to change the properties of the host. It has been surprisingly discovered that vanadium has this character in iron.

Accordingly, the present invention shows the compositional effects on the relaxation rate by doping iron with a lower-Z isostructural transition metal element (i.e., an element with a lower atomic number than iron), such as vanadium. It should be noted that other lower-Z elements may also be used, such as, for example, titanium (Ti), chromium (Cr), and manganese (Mn). When determining which elements can be alloyed with iron to reduce the relaxation rate, the gyromagnetic ratio or g factor estimated from Einstein-de-Haas measurements was considered. It has been discovered that as lower-Z elements from titanium to manganese (according to the periodic table) are doped with iron, the g factor continues to become smaller, consistent with a reduction in the orbital moment. While other lower-Z elements may be alloyed with iron, the present invention is described herein primarily in the context of alloying iron with vanadium for specificity and clarity.

In accordance with the present invention, ferromagnetic thin films of iron that have reduced damping and methods of making the same are provided. It should be noted that pure iron is a ferromagnet (i.e., has a spontaneous magnetization alignment) with the lowest intrinsic relaxation rate of all of the ferromagnets. Iron (Fe) has a relaxation rate of about λ/4π=130 MHz. Alloys and compounds generally have higher relaxation rates. For example, Permalloy (Ni₈₀Fe₂₀) has a relaxation rate of about λ/4π=180 MHz. The increase in relaxation rate may arise from electronic scattering, tracking the resistivity (ρ), increased on alloying.

It should be noted that the relaxation rate (λ) is derived from the Landau-Lifshitz (LL) equation shown below:

$$\frac{ⅆ M}{ⅆ t} = - {μ}_{0} \vert γ \vert ( M \times H ) - \frac{λ}{{M}_{s}^{2}} ( M \times M \times H ) ,$$

where M is the magnetization vector, H is the local magnetic field vector, Mₛ is the saturation magnetization (in A/m), μ₀ is the permeability of free space, γ is the gyromagnetic ratio, and λ is the relaxation rate, where lambda/4π is in cgs units generally tabulated in FMR studies.

The magnetization (M) changes its orientation in response to magnetic applied fields (H) through precessional dynamics, operating at sub-nanosecond time scales. Magnetization dynamics control attainable data rates in spin electronics. The relaxation rate describes how long the magnetization (M) requires to switch by 180°, how stable it is in nanoscale volumes at finite temperatures, and how much spin current is needed to induce motion. Manipulation of the relaxation rate may raise data rate limits above 1 GHz. For example, the finite time required for the bit magnetization to fully reverse sets a limit to the data rate. Faster full switching at sub-nanosecond time scales may be achieved by enhancing the relaxation rate. In another example, thermal noise poses another limit to attainable data rates. Nanoscale sensors operating at room temperature above 1 GHz are dominated by magnetic noise. Signal to noise in this domain is inversely dependent upon the relaxation rate and independent of ΔR/R. Reducing the relaxation rate may increase data rates. In yet another example, with spin momentum transfer (SMT) switching, the critical currents (i_{crit}) are directly proportional to the relaxation rate. Low power operation and short times to charge the lines may be attainable by providing low critical currents and a reduction of the relaxation rate.

The present invention provides a ferromagnetic structure that includes a substrate and a ferromagnetic thin film of iron formed on the substrate. As used herein, thin film generally refers to a film or a layer that has a thickness between an atomic layer and about 10 microns.

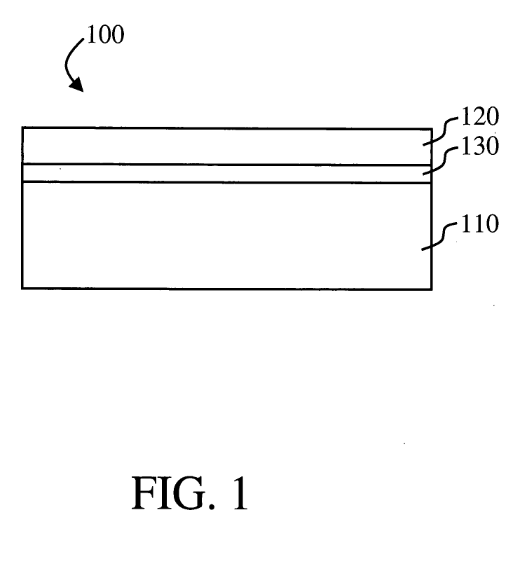

FIG. 1 illustrates schematically, in cross-section, a portion of a ferromagnetic structure 100 in accordance with some embodiments of the present invention. Ferromagnetic structure 100 includes a substrate 110 and a ferromagnetic thin film 120.

In accordance with some embodiments of the present invention, structure 100 also includes an intermediate layer 130. The intermediate layer 130 may be deposited or grown on the underlying substrate and positioned between substrate 110 and ferromagnetic thin film 120. Examples of the intermediate layer include Ag, Cr, or any other nonmagnetic (paramagnetic) metal. In accordance with one embodiment, the intermediate layer 130 is grown on the substrate 110 at the interface between the substrate 110 and the magnetic thin film 120 by oxidizing the substrate during the growth of the magnetic thin film. The intermediate layer 130 may be used to relieve strain that might otherwise occur in the magnetic thin film 120 as a result of differences in the lattice constants of the substrate 110 and the magnetic thin film 120. If such strain is not relieved by the intermediate layer 130, the strain may cause defects in the crystalline structure of the magnetic thin film 120.

The substrate 110, in accordance with some embodiments, is a monocrystalline oxide wafer. In some embodiments, the wafer may be a semiconductor wafer. Examples of Group IV semiconductor materials include silicon, germanium, mixed silicon and germanium, mixed silicon and carbon, mixed silicon, germanium and carbon, and the like. In other embodiments, the wafer may be a magnesium oxide wafer. Alternatively, the wafer may be of a material from any of the Group IIIA and VA elements (III-V semiconductor compounds), mixed III-V compounds, Group II (A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like. Any suitable substrate that provides an acceptable lattice match with the ferromagnetic thin film 120 may be used.

In some embodiments, the substrate 110 may be heated during the deposition of the ferromagnetic thin film 120. For example, the substrate 110 may be heated at temperatures ranging from room temperature to 300° C. during the deposition. Heating the substrate 110 during the deposition may yield better crystalline quality of the thin film 120.

As described above, a ferromagnetic thin film of iron is formed on the substrate. An element selected from the group consisting of titanium (Ti), vanadium (V), chromium (Cr), and manganese (Mn) (i.e., lower Z transition metal elements than iron) is alloyed with the ferromagnetic thin film of iron to reduce the relaxation rate of the ferromagnetic thin film. However, it should be noted that any other suitable group V (e.g., niobium, tantalum, hafnium) or group VI (e.g., chromium, molybdenum, tungsten) transition metal element or lower valence transition metal element may also be alloyed with iron to form the ferromagnetic thin film. When the alloyed element is vanadium, the ferromagnetic thin film 120 preferably has the composition Fe₁₋ₓVₓ, where x may be between 0 and 0.99, but is preferably between 0 and about 0.33. In another suitable example, a ternary alloy may be also be formed.

It should be noted that although the embodiments of the invention relates to reducing the relaxation rate of iron, this embodiment is not limited only to reducing the relaxation rate of iron. Rather, the invention may also be applied to other transition metal magnetic elements, such as, for example, nickel, cobalt, or any suitable alloy (e.g., Permalloy or Ni₈₀Fe₂₀).

In some embodiments, the alloying element is vanadium and the thin film 120 is deposited by co-sputtering iron and vanadium onto the substrate. However, the deposition may be performed using various techniques, such as physical vapor deposition (e.g., evaporation, sputtering, etc.), chemical vapor deposition (e.g., plasma enhanced chemical vapor deposition, metal organic chemical vapor deposition, etc.), pulsed laser deposition, electroplating, molecular beam epitaxy (MBE), migration enhanced epitaxy (MEE), atomic layer epitaxy (ALE), chemical solution deposition (CSD), or any other suitable approach for depositing the ferromagnetic thin film.

The following non-limiting, illustrative example illustrates various combinations of materials useful in the present invention in accordance with various alternative embodiments. This example is merely illustrative, and it is not intended that the invention be limited to the illustrative example.

Clearly, these embodiments specifically describing structures are meant to illustrate embodiments of the present invention and not limit the present invention. There are a multiplicity of other combinations and other embodiments of the present invention. For example, the present invention includes structures and methods for fabricating material layers which form semiconductor structures, devices, and integrated circuits including other layers such as metal and non-metal layers. By using the embodiments of the present invention, it is now simpler to integrate devices that include ferromagnetic layers. This allows manufacturing costs to decrease and yield and reliability to increase.

### EXAMPLE

### A Fe₁₋ₓVₓ (100) Thin Film on an MgO (100) Wafer

In accordance with one embodiment, an epitaxial Fe₁₋ₓVₓ (100) thin film is deposited onto a magnesium oxide single crystal wafer (MgO oriented in the (100) direction) by cosputtering from confocal Fe and V targets in an ultra-high vacuum (UHV) chamber at a base pressure of about 1×10⁻⁹ torr. The concentration of Vₓ as defined in Fe₁₋ₓVₓ can be in the range of 0 to about 33%. In this example, the Fe₁₋ₓVₓ thin films have a thickness of about 50 nanometers.

The structural properties of the thin films were characterized by x-ray diffraction (XRD) with a Scintag X₂ x-ray diffractometer in the conventional Bragg-Brentano (θ-2θ) Geometry. The static magnetic properties were characterized using a vibrating sample magnetometer (VSM). Saturation moments were measured by VSM.

Microstructural Characterization

The substrate was heated at temperatures ranging from room temperature to 300° C. during the deposition. It should be noted that no (200) diffracted intensity is present when the film was grown at room temperature. However, the peak intensity is slightly larger for the deposition at 200° C., which indicates that deposition at this temperature yields better crystalline quality. The lattice constant of Fe (BCC) is 0.287 nm, while that of MgO (rocksalt) is 0.412 nm, which is about 2 times of that of Fe.

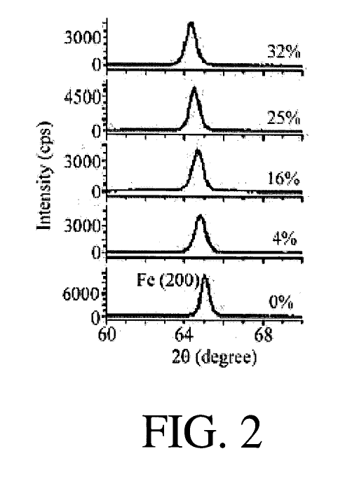

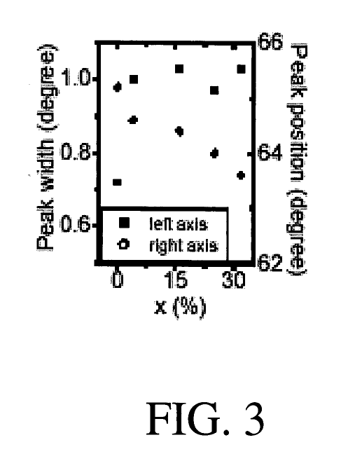

FIGS. 2 and 3 show the effect of vanadium composition on the crystal quality of the thin films. FIG. 2 illustrates the x-ray diffraction (XRD) spectra of the ferromagnetic films deposited at 200° C. with various vanadium compositions. FIG. 3 shows the extracted parameters from the x-ray diffraction spectra. As shown in both FIGS. 2 and 3, the peak width broadens as vanadium is initially introduced into the iron. However, as the vanadium concentration increases up to 32%, there is no obvious difference in peak width of the spectra. The peak position shifts to a lower angle as the vanadium concentration increases, which indicates that the lattice parameter became larger from the addition of vanadium. The XRD results are in agreement with the fact that both Fe and V have the BCC crystal structure and the lattice constant of V (0.302 nm) is slightly (5%) larger than that of Fe, which provides the high solid solubility of the alloy and good crystalline quality of the epitaxial thin film.

Static Magnetic Properties

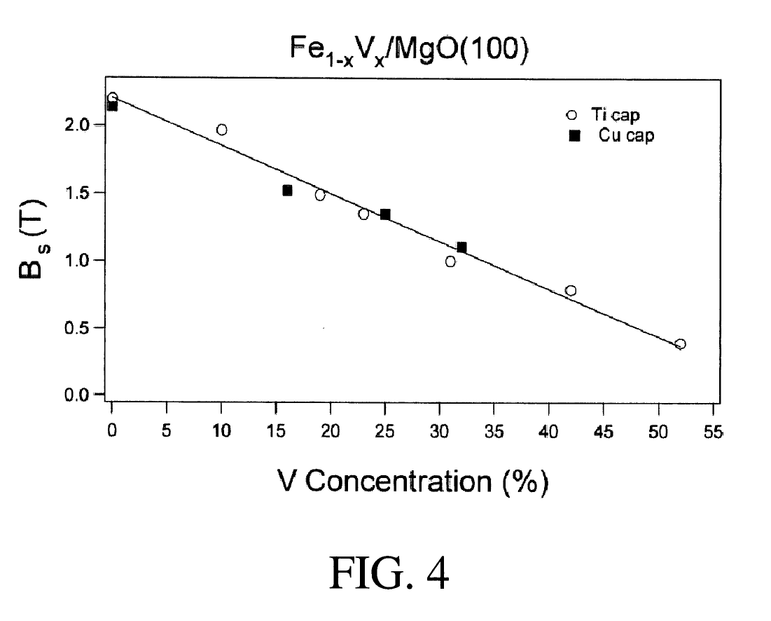

FIG. 4 shows the vibrating sample magnetometer (VSM) measured magnetic moments of Fe₁₋ₓVₓ with different vanadium concentrations. As the concentration of vanadium increases from 0 to 32%, magnetic moments decrease linearly from 2.2 T to 1.1 T. Vanadium moments are assumed to couple antiferromagnetically to iron (Fe) moments. While the overall magnetic moment is reduced by vanadium dopants, it is still on the order of the moment of permalloy (Ni₈₀Fe₂₀) (0.9 T), and far greater than that of ferrites.

Ferromagnetic Resonance (FMR) studies

In epitaxial Fe₁₋ₓVₓ thin films, the relaxation rate may be reduced to about 70 MHz, or about half the prior lowest known value for a metallic film, for 31% vanadium. The relaxation rate has been determined through variable frequency (f=0-18 GHz) FMR measurement to separate homogeneous from inhomogeneous broadening, according to:

$$Δ H ( ω ) = Δ {H}_{0} + 1.16 \frac{α}{γ} ω .$$

For intrinsic magnetic relaxation, it has been derived that a should be proportional to (g-2)². See, e.g., V. Kambersky, Can. J. Phys. 48, 2906 (1970). Iron has g value in the range from about 2.09 to 2.14 (near 2), the value of electron spin moments. As shown in the following equation, g may be directly related to the ratio of orbital and spin momentum.

$$\frac{{μ}_{L}}{{μ}_{S}} = \frac{g}{2} - 1$$

In accordance with the above equation, a g of 2 means pure spin magnetism, while a g larger than 2 (as in Fe) may have some orbital moment. From the above-mentioned equations, it can be determined that lower damping is related to a lower ratio of orbital and spin momentum.

In addition, the recently proposed electron-scattering mechanism of Ingvarrson may be considered. Ingvarrson proposed that increasing conduction electron scattering rates can lead to enhanced damping. However, resistivity/scattering rates should increase with increasing vanadium content, and this mechanism would predict an increase, rather than a decrease, in damping.

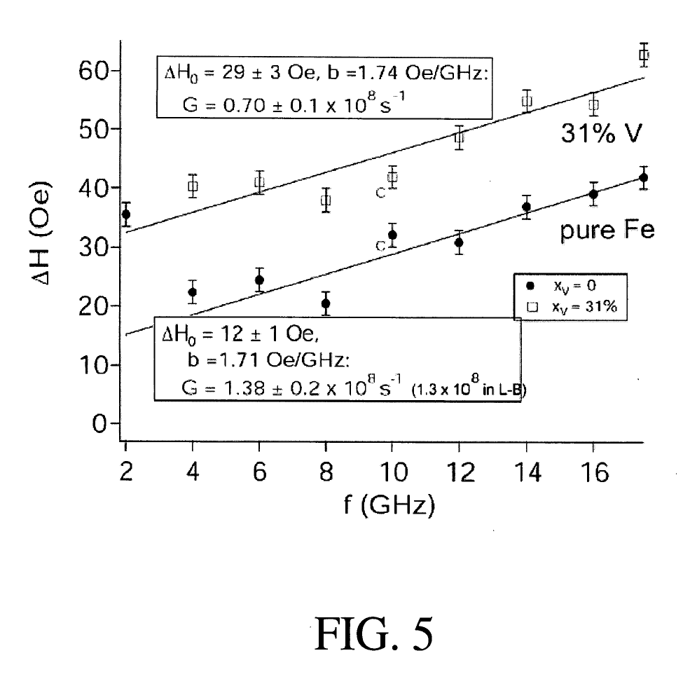

FIG. 5 illustrates graphically the relationship of the FMR linewidth (ΔH) and the frequency. If all scattering arises from one process, ΔH=γ⁻¹τ⁻¹ (where τ⁻¹ is the relaxation rate and describes a scattering process out of one specified state and into any other) and the field linewidth is a direct measurement of the relaxation rate.

$$\begin{matrix}{μ}_{0} Δ H ( ω ) = {μ}_{0} Δ {H}_{0} + 1.16 \frac{α}{γ} ω \\ {μ}_{0} Δ H ( ω ) = {μ}_{0} Δ {H}_{0} + 1.16 \frac{λ}{{μ}_{0} {γ}^{2} {M}_{s}} ω\end{matrix}$$

The similar slope of ΔH vs. frequency (1.7 Oe/GHz) for the alloy implies an equivalent value of α˜0.004. Ni₈₁Fe₁₉, which has a similar moment of B_{S}=1.1 T, has a slope of 3.3 Oe/GHz (α-0.008). It should be noted that the relaxation rate for the ferromagnetic film having 31% vanadium is half of the relaxation rate of pure iron. Thus, an alloying method was demonstrated to reduce the relaxation rate of pure iron, which undoped possesses the lowest intrinsic relaxation rate of all elemental ferromagnets.

Accordingly, the alloyed ferromagnetic thin film of the present invention may be implemented into any suitable device or application.

One such application is in the area of magnetic memory and spin electronics. In general, these memory devices use the spins of the electrons, though their magnetic moments, rather than the charge of the electrons, to indicate the presence of a “1” or a “0” in each memory cell.

Magnetic tunnel junctions (MTJ) devices may be used as memory cells for use in a nonvolatile magnetic random access memory (MRAM) array. Each memory cell or MTJ is disposed between conductive lines that are oriented in different directions. An MRAM array of memory cells includes a plurality of conductive lines running parallel to one another in a first direction (bit lines) and a plurality of conductive lines running parallel to one another in a second direction (word lines).

A magnetic tunnel junction includes two ferromagnetic layers separated by a thin insulating tunnel barrier layer. The insulating tunnel barrier layer is thin enough that quantum mechanical tunneling occurs between the two ferromagnetic layers. The tunneling phenomenon is electron-spin dependent, making the magnetic response of the MTJ device a function of the relative orientations and spin polarizations of the two ferromagnetic layers. For example, one of the ferromagnetic layers may have its magnetization fixed or pinned, while the other ferromagnetic layer may be free to have its magnetization rotated in the presence of a magnetic field. The resistance of the magnetic tunnel junction is based at least in part on the moment's relative alignment. For example, the resistance is generally lower when the two ferromagnetic layers are oriented in the same direction and higher when the two layers are oriented in opposite directions. These two states of the memory cell are read as “1s” and “0s”.

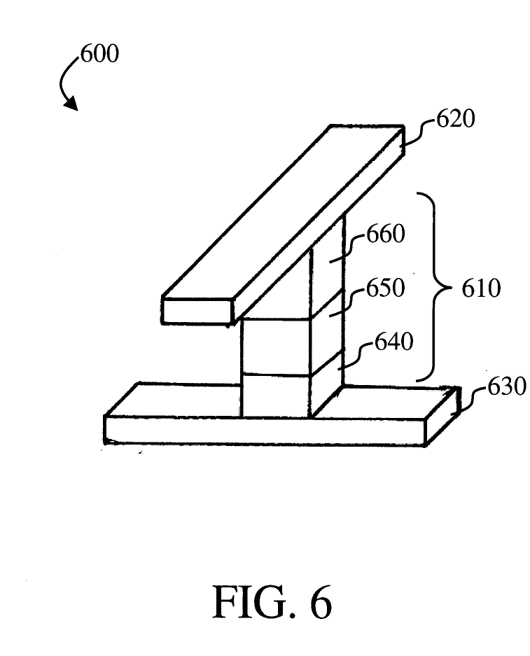

In accordance with some embodiments of the present invention, improved MTJ memory cells and structures may be provided. FIG. 6 is an illustrative view of a portion of the MRAM array that includes a magnetic tunnel junction (MTJ) cell, which includes at least one ferromagnetic thin film in accordance with some embodiments of the present invention. A magnetic random access memory (MRAM) array 600 includes a plurality of magnetic tunnel junction (MTJ) memory cells 610, where each memory cell 610 is located at an intersection between a conductive row line 620 and a conductive column line 630. Each column line 620 is preferably oriented in a different direction to each intersecting row line 610. For example, in some embodiments, each column line 620 may be oriented at right angles (perpendicular) to each intersecting row line 610. It should be noted that each conductive row line preferably operates as a word line and each conductive column line preferably operates as a bit line. It should also be noted that although only one word line and one bit line (e.g., row line 610 and column line 620) are illustrated in FIG. 6, the MRAM array 600 may include any number of conductive lines.

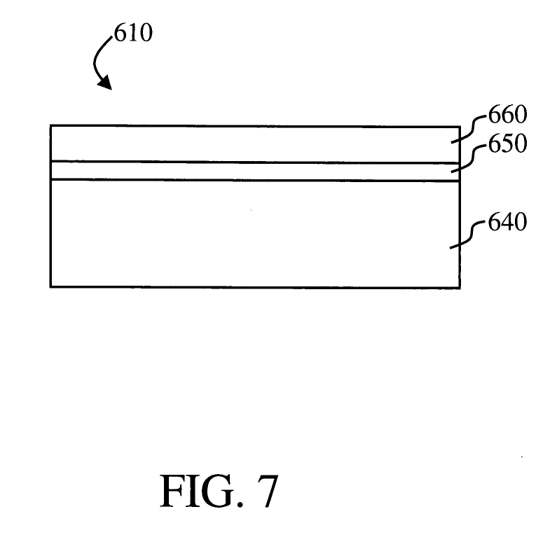

The structure of the MTJ memory cell 610 is shown schematically in FIGS. 6 and 7. MTJ cell 610 is formed of a series of stacked layers. MTJ memory cell 610 includes a fixed ferromagnetic layer 640, such as CoFe or Permalloy (Ni₈₀Fe₂₀), a thin tunneling barrier layer 650, and a free ferromagnetic layer 660. The thin tunneling barrier layer 650 may be an oxide, such as, for example, a layer of magnesium oxide (MgO). However, any other suitable barrier layer may also be used.

In some embodiments, the fixed ferromagnetic layer 640 may be formed from a variety of ferromagnetic materials, such as alloys of Co and one or more other elements, including Co—Pt—Cr alloys, Co13 Cr—Ta alloys, or any other suitable alloy (e.g., ternary alloys, quaternary alloys, etc.). Low magnetization materials may be used in the MTJ memory cell 610 to reduce the magnetostatic interaction between the fixed ferromagnetic layer 640 and the free ferromagnetic layer 660 and between adjacent MTJ memory cells.

As described above, free ferromagnetic layer 660 may be a ferromagnetic thin film of iron that is formed on the substrate. An element selected from the group consisting of titanium (Ti), vanadium (V), chromium (Cr), and manganese (Mn) (i.e., lower Z transition metal elements than iron) is alloyed with the ferromagnetic thin film of iron to reduce the relaxation rate of the ferromagnetic thin film. Alternatively, any other suitable group V (e.g., niobium, tantalum, haftiium) or group VI (e.g., chromium, molybdenum, tungsten) transition metal element or lower valence transition metal element may also be alloyed with iron to form the ferromagnetic thin film. When the alloyed element is vanadium, the free ferromagnetic layer 660 preferably has the composition Fe₁₋ₓVₓ where x may be between 0 and 0.99, but is preferably between 0 and about 0.33.

In some embodiments, the alloying element is vanadium and the free ferromagnetic layer 660 is formed by co-sputtering iron and vanadium onto the substrate. However, the deposition may be performed using various techniques, such as physical vapor deposition (e.g., evaporation, sputtering, etc.), chemical vapor deposition (e.g., plasma enhanced chemical vapor deposition, metal organic chemical vapor deposition, etc.), pulsed laser deposition, electroplating, molecular beam epitaxy (MBE), migration enhanced epitaxy (MEE), atomic layer epitaxy (ALE), chemical solution deposition (CSD), or any other suitable approach for depositing the ferromagnetic thin film.

In some embodiments, the magnetic tunnel junction 610 may include a capping layer. The capping layer may be, for example, titanium (Ti), platinum (Pt), copper (Cu), tantalum (Ta), or any other suitable element that may be used to form a capping layer. The capping layer may be deposited or grown on the free ferromagnetic layer 600.

In some embodiments, the magnetic tunnel junction 610 may be formed on a substrate. The substrate, in accordance with some embodiments, may be a monocrystalline oxide wafer. In some embodiments, the wafer may be a semiconductor wafer. Examples of Group IV semiconductor materials include silicon, germanium, mixed silicon and germanium, mixed silicon and carbon, mixed silicon, germanium and carbon, and the like. In other embodiments, the wafer may be a magnesium oxide wafer. Alternatively, the wafer may be of a material from any of the Group IIIA and VA elements (III-V semiconductor compounds), mixed III-V compounds, Group II (A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like. Any suitable substrate that provides an acceptable lattice match with the magnetic tunnel junction 610 may be used.

In some embodiments, a template layer or intermediately layer may be formed within the magnetic tunnel junction 610 to increase the spin polarization. For example, a layer of iron or any other suitable high spin polarization material is preferably thick enough to provide a suitable template for the adjacent layer growth (e.g., at least one monolayer) while increasing the spin polarization.

Using the reduced relaxation rate alloy (Fe₁₋ₓVₓ) in a Fe₁₋ₓVₓ/MgO/Fe magnetic tunnel junction, a fourfold reduction in spin momentum transfer (SMT) switching power may be provided.

In some embodiments, the free ferromagnetic layer (e.g., Fe₁₋ₓVₓ or any other reduced relaxation rate alloy) may be doped with rare earth elements. For example, portions of the free ferromagnetic layer may be selectively doped with small concentrations of terbium (Tb) to enhance the relaxation rate or damping factor by orders of magnitude, which may decrease the sub-nanosecond settling time of switched magnetization states. Tb-doped layers may be formed by confocal sputtering or any other suitable deposition technique. For example, (Fe₁₋ₓVₓ)_{1-y}:Tb_{y} doped layers may be formed by confocal sputtering from the Fe₁₋₃Vₓ alloy and elemental Tb targets under an applied field of 20 Oe. In other embodiments, the fixed ferromagnetic layer may be doped with a rare earth element. For example, portions of Permalloy (Ni₈₀Fe₂₀) may be doped with terbium.

In accordance with some embodiments of the present invention, the alloyed ferromagnetic thin films may be used in magnetic sensors. More particularly, as magnetization fluctuations (“mag-noise) in the ferromagnetic free layer is a limiting factor in read head performance, the alloyed ferromagnetic thin films may be used in giant magnetoresistive (GMR) spin valve sensors. GMR spin valve sensors may be used to read information from storage media (e.g., hard drives).

It should be noted that GMR is a quantum mechanical effect observed in thin film magnetic multilayer structures that are composed of alternative ferromagnetic and non-magnetic layers. Similar to magnetic tunnel junctions, GMR spin valve sensors are electron-spin dependent, making the magnetic response of the GMR spin valve a function of the relative orientations and spin polarizations of the two ferromagnetic layers. For example, one of the ferromagnetic layers may have its magnetization fixed or pinned, while the other ferromagnetic layer may be free to have its magnetization rotated in the presence of a magnetic field. The resistance of the magnetic tunnel junction is based at least in part on the moment's relative alignment.

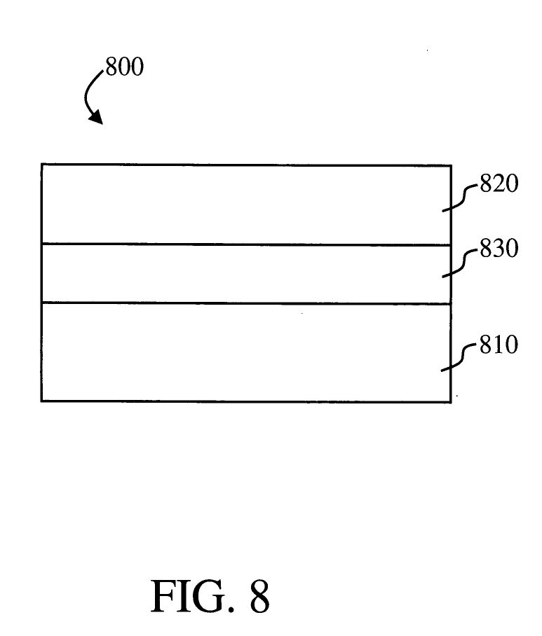

In accordance with some embodiments of the present invention, an improved GMR spin valve and structures may be provided. FIG. 8 is an illustrative cross-sectional view of a GMR spin valve structure that includes at least one ferromagnetic thin film in accordance with some embodiments of the present invention. As shown in FIG. 8, the spin valve 800 is formed of a series of stacked layers. The spin valve 800 includes at least two ferromagnetic layers: a fixed ferromagnetic layer 810, such as CoFe or Permalloy (Ni₈₀Fe₂₀), and a free ferromagnetic layer 820. As described above, free ferromagnetic layer 820 may be a ferromagnetic thin film of iron. An element selected from the group consisting of titanium (Ti), vanadium (V), chromium (Cr), and manganese (Mn) (i.e., lower Z transition metal elements than iron) is alloyed with the ferromagnetic thin film of iron to reduce the relaxation rate of the ferromagnetic thin film. However, it should be noted that any suitable group V (e.g., niobium, tantalum, hafnium) or group VI (e.g., chromium, molybdenum, tungsten) transition metal element or lower valence transition metal element may also be alloyed with iron to form the ferromagnetic thin film. When the alloyed element is vanadium, the free ferromagnetic layer 820 preferably has the composition Fe₁₋ₓVₓ where x may be between 0 and 0.99, but is preferably between 0 and about 0.33.

A non-magnetic spacer layer 830 may be formed between the fixed ferromagnetic layer 810 and the free ferromagnetic layer 820. The spacer layer may be, for example, a non-magnetic layer of copper (Cu), gold (Au), silver (Ag), Al₂O₃, SiO₂, MgO, AlON, GaO, Bi₂O₃, SrTiO₂, AlLaO₃, or any other suitable element that may be used to form a non-magnetic spacer layer.

In some embodiments, the GMR spin valve sensor 800 may be used in a magnetoresistive magnetic heads. In a magnetic head, the resistance value is proportional to the angle made between the direction of magnetization of the free ferromagnetic layer 820 and the direction of magnetization of the fixed ferromagnetic layer 810.

It should be noted that although magnetic tunnel junction 600 and GMR spin valve 800 are described are using a fixed or pinned ferromagnetic layer, these devices may function without a pinned layer or with a ferromagnetic layer that is only weakly pinned.

In accordance with some embodiments of the present invention, the alloyed ferromagnetic thin films may be used in the area of telecommunications devices (e.g., cellular telephones). Prior metallic ferromagnets lose a significant amount of energy. Because the loss can be reduced substantially by using the present invention, iron-based alloys with high moment (high frequency range) and easy process integration (e.g., room temperature deposition) can replace monolithic ferrite elements, which are currently glued or affixed directly to integrated circuits used in, for example, telecommunications devices. Moreover, it should be noted that the iron-based alloys may be used directly in existing technologies.

Ferrite materials, such as pure or doped yttrium iron garnet (YIG) have been used as resonating elements, typically in the form of a crystal or a thin layer, to construct resonators useful in high frequency oscillators, filters and other high frequency applications. Ferrite resonators have several applications, including high frequency filters and oscillators for use in high frequency transceiver systems, such as those that operate in the microwave and millimeter wave frequency bands from 1 GHz and greater. However, while these ferrite materials may be used in components that can operate at sufficiently high frequencies with low noise throughout the tuning bandwidth, there are a number of unacceptable disadvantages to using ferrite materials. For example, the tuning of these YIG components is relatively slow, ferrite materials are expensive, and ferrite material require the application of large external fields (high current consumption).

In accordance with some embodiments of the present invention, the alloyed ferromagnetic thin films may be integrated in radio-frequency and microwave components and devices (e.g., filters, isolators, phase shifters, inductors, transformers, circulators, etc.).

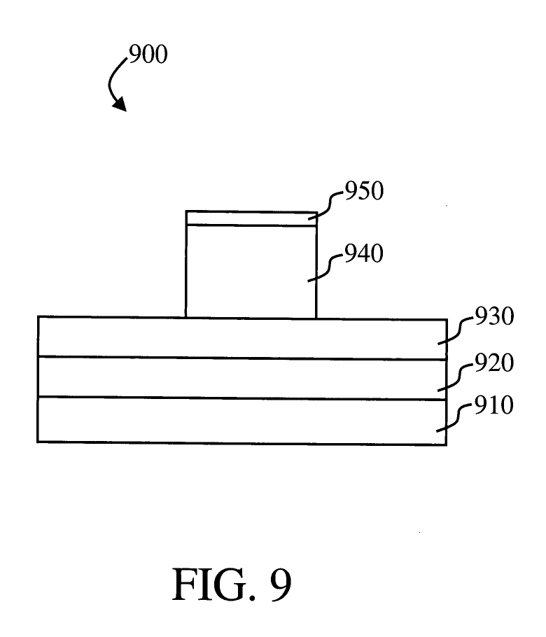

FIG. 9 is an illustrative cross-sectional view of a filter structure that includes at least one ferromagnetic thin film in accordance with some embodiments of the present invention. As shown in FIG. 9, the filter structure 900 is formed of a series of stacked layers. The filter structure 1000 includes a substrate 910, a first electrode layer 920, a frequency layer 930, a dielectric layer 940, and a second electrode layer 950.

The filter structure 900 is formed on the substrate 910. The substrate 910, in accordance with some embodiments, may be a semiconductor wafer (e.g., GaAs). Examples of Group IV semiconductor materials include silicon, germanium, mixed silicon and germanium, mixed silicon and carbon, mixed silicon, germanium and carbon, and the like. In other embodiments, the wafer may be a magnesium oxide wafer. Alternatively, the wafer may be of a material from any of the Group IIIA and VA elements (III-V semiconductor compounds), mixed III-V compounds, Group II (A or B) and VIA elements (II-VI semiconductor compounds), and mixed II-VI compounds. Examples include gallium arsenide (GaAs), gallium indium arsenide (GaInAs), gallium aluminum arsenide (GaAlAs), indium phosphide (InP), cadmium sulfide (CdS), cadmium mercury telluride (CdHgTe), zinc selenide (ZnSe), zinc sulfur selenide (ZnSSe), and the like.

The first electrode layer 920 is formed over the substrate 910. The first electrode layer may be, for example, silver (Ag), gold (Au), platinum (Pt), or any other suitable highly conductive metal.

The frequency layer 930 is formed over the first electrode layer 920. The frequency layer 930 may be a ferromagnetic thin film of iron. An element selected from the group consisting of titanium (Ti), vanadium (V), chromium (Cr), and manganese (Mn) (i.e., a lower Z transition metal element than iron) is alloyed with the ferromagnetic thin film of iron to reduce the relaxation rate of the ferromagnetic thin film. Alternatively, any other suitable group V (e.g., niobium, tantalum, hafnium) or group VI (e.g., chromium, molybdenum, tungsten) transition metal element or lower valence transition metal element may also be alloyed with iron to form the frequency layer 930. For example, when the alloyed element is vanadium, the frequency layer 930 preferably has the composition Fe₁₋ₓVₓ, where x may be between 0 and 0.99, but is preferably between 0 and about 0.33.

The dielectric layer 940 is formed over the frequency layer 930. The dielectric layer may be, for example, a layer of silicon dioxide (SiO₂). The second electrode layer 950 is formed over the dielectric layer 940. The second electrode layer may be, for example, silver (Ag), gold (Au), platinum (Pt), or any other suitable highly conductive metal.

The filter structure 900 may be used in a number of devices, where electromagnetic waves may propagate through the filter structure 900. The filter structure 900 may be tuned to filter out a range of frequencies by applying an external magnetic field. The application of an external magnetic field modifies the manner in which the waves propagate throughout the filter structure 900.

In some embodiments, the filter structure 900 may be used to fabricate a band-stop filter, which relies on ferromagnetic resonance (FMR) to absorb microwave power at the FMR frequency. The resonance frequency may be tuned by applying an external field (e.g., with the use of an electromagnet). In some embodiments, the band-stop filter has a center frequency in the 0-30 GHz range which is tunable with an external magnetic field.

It should be noted that the frequency selectivity of the filter structure 900 is directly proportional to the relaxation rate.

In some embodiments, filter structure 900 may be used to provide an improved radio frequency identification (RFID) tag. One type of RFID system uses a magnetic field modulation system to monitor RFID tags. The system generates a magnetic field that becomes detuned when the tag is passed through the magnetic field. In some embodiments, the RFID tag may be encoded with an identification code to distinguish between a number of different tags. Filter structure 900 may be used in each RFID tag such that each RFID tag filters out a predetermined frequency. Alternatively, filter structure 1000 may be used in a radio frequency (RF) transponder device affixed to an object to be monitored. In response to an interrogator transmitting an interrogation signal to the RFID tag, the RFID tag generates and transmits a responsive signal. It should be noted that the interrogation signal and the responsive signal are RF signals produced by an RF transmitter circuit.

Upon receiving the responsive signal, the interrogator may, for example, recognize the identity of the object that the RFID tag is attached. The filter structure 1000 may be integrated into the transponder portion of the RFID tag. Forming the filter structure 1000 within the RFID tag allows the RFID tag to be tuned to a particular frequency by applying an external magnetic field. The RFID tag may be tuned to respond to a desired frequency from a wide range of available frequencies.

It should be noted that the RFID tag may be included in any suitable housing or packaging.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements includes not only those elements but may also include other elements not expressly listed or inherent to such process, method, article, or apparatus.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

The following references are incorporated by reference herein in their entireties:

N. Smith and P. Arnett, Appl. Phys. Lett. 78, 1448 (2001).

W. Bailey, P. Kabos, F. Mancoff, and S. Russek, IEEE Trans. Magn. 37, 1749 (2001).

S. G. Reidy, L. Cheng, and W. E. Bailey, Appl. Phys. Lett. 82, 1254 (2003).

L. Cheng, H. Song, and W. E. Bailey, IEEE Trans. Magn. 40, 2350 (2004).

R. Urban, G. Woltersdorf, and B. Heinrich, Phys. Rev. Lett. 87, 217204 (2001).

S. Ostanin, J. B. Staunton, S. S. A. Razee, C. Demangeat, B. Ginatempo, and E. Bruno, Phys. Rev. B 69, 64425 (2004).

J. Kunes and V. Kambersky, Phys. Rev. B 65 212411 (2002).

F. J. Himpsel, J. E. Ortega, G. J. Mankey, and R. F. Willis, Adv. in Phys. 47, 511 (1998).

V. Kambersky, Can. J. Phys. 48, 2906 (1970).

F. Schreiber, J. Pflaum, Z. Frait, Th. Mughe, and J. Pelzl, Sol. St. Comm. 93, 965 (1995).

M. Blume, S. Geschwind, and Y. Yafet, Phys. Rev. 181, 478 (1969).

P. Lubitz, M. Rubinstein, D. B. Chrisey, J. S. Hotwitz, and P. R. Broussard, J. Appl. Phys. 75, 5595 (1994).

What is claimed is:

1. A method of decreasing the relaxation rate of a magnetic material, the method comprising:
providing a substrate; and
forming a ferromagnetic thin film on the substrate, wherein the thin film is composed of iron having a relaxation rate that is alloyed with an amount of an element selected from the group consisting of titanium (Ti), vanadium (V), chromium (Cr), and manganese (Mn) to decrease the relaxation rate of iron.

2. The method of claim 1, wherein the element is vanadium, thereby forming the alloy of Fe₁₋ₓVₓ, wherein x is between about 0.01 and about 0.33.

3. The method of claim 1, wherein the forming the ferromagnetic thin film further comprises sputtering iron and the element onto the substrate.

4. The method of claim 1, wherein the substrate is magnesium oxide (MgO).

5. A method of decreasing the relaxation rate of a magnetic material in a magnetic device, the magnetic material comprising iron, the method comprising adding to the iron an amount of at least one lower-Z transition metal element selected from the group consisting of titanium (Ti), vanadium (V), chromium (Cr), and manganese (Mn).

6. The method of claim 5, wherein the at least one lower-Z transition metal element is vanadium, thereby forming an alloy of Fe₁₋ₓVₓ, wherein x is between about 0.01 and about 0.33.

7. The method of claim 5, wherein the adding further comprises sputtering iron and the element onto a substrate.

8. The method of claim 5, wherein the adding the at least one lower-Z transition metal element reduces the relaxation rate of iron.

9. A ferromagnetic structure comprising:
a substrate; and
a ferromagnetic thin film of iron formed on the substrate, wherein an element selected from the group consisting of titanium (Ti), vanadium (V), chromium (Cr), and manganese (Mn) is alloyed with the ferromagnetic thin film of iron to reduce the relaxation rate of the ferromagnetic thin film.

10. The ferromagnetic structure of claim 9, wherein the element is vanadium, thereby forming an alloy of Fe₁₋ₓVₓ, wherein x is between about 0.01 and about 0.33.

11. The ferromagnetic structure of claim 9, wherein the ferromagnetic thin film is formed by cosputtering iron and the element onto the substrate.

12. The ferromagnetic structure of claim 9, wherein the substrate is magnesium oxide (MgO).

13. A magnetic tunneling junction memory cell, the memory cell comprising:
a fixed ferromagnetic layer;
a barrier layer formed on the fixed ferromagnetic layer; and
a free ferromagnetic layer formed on the barrier layer, wherein the free ferromagnetic layer comprises an alloy of (a) iron and (b) a lower-Z transition metal element selected from the group consisting of titanium (Ti), vanadium (V), chromium (Cr), and manganese (Mn), and wherein the relaxation rate of iron is reduced by alloying the iron with the lower-Z transition metal element.

14. The memory cell of claim 13, wherein the lower-Z transition metal element is vanadium, thereby forming an alloy of Fe₁₋ₓVₓ, wherein x is between about 0.01 and about 0.33.

15. The memory cell of claim 13, wherein the ferromagnetic thin film is formed by sputtering iron and the lower-Z transition metal element onto the barrier layer.

16. A spin valve structure, the spin valve structure comprising:
a fixed ferromagnetic layer;
a non-magnetic spacer layer formed on the fixed ferromagnetic layer; and
a free ferromagnetic layer formed on the barrier layer, wherein the free ferromagnetic layer comprises an alloy of (a) iron and (b) a lower-Z transition metal element selected from the group consisting of titanium (Ti), vanadium (V), chromium (Cr), and manganese (Mn), and wherein the relaxation rate of iron is reduced by alloying the iron with the lower-Z transition metal element.

17. The spin valve structure of claim 16, wherein the lower-Z transition metal element is vanadium, thereby forming an alloy of Fe₁₋ₓVₓ, wherein x is between about 0.01 and about 0.33.

18. The spin valve structure of claim 16, wherein the free ferromagnetic layer is formed by sputtering iron and the lower-Z transition metal element onto the non-magnetic spacer layer.

19. A method of reducing the relaxation rate in a magnetoresistive element, the method comprising:
providing a fixed ferromagnetic layer;
forming a non-magnetic spacer layer on the fixed ferromagnetic layer; and
forming a free ferromagnetic layer, wherein the free ferromagnetic layer is composed of an alloy of iron and a lower-Z transition metal element selected from the group consisting of titanium (Ti), vanadium (V), chromium (Cr), and manganese (Mn) such that the alloying reduces the relaxation rate of iron, thereby reducing noise due to thermal magnetization fluctuations.

20. The method of claim 19, further comprising doping the free ferromagnetic layer with a rare earth element.

21. The method of claim 20, wherein the rare earth element is terbium.

22. The method of claim 19, wherein the lower-Z transition metal element is vanadium, thereby forming an alloy of Fe₁₋ₓVₓ wherein x is between about 0.01 and about 0.33.

23. The method of claim 19, wherein the forming the free ferromagnetic layer further comprises sputtering iron and the lower-Z transition metal element onto the non-magnetic spacer layer.

24. A tunable band-pass filter, the filter comprising:
a substrate;
a first electrode layer formed on the substrate;
a ferromagnetic thin film formed on the first electrode layer, wherein the ferromagnetic thin film is composed of an alloy of (a) iron and (b) an element selected from the group consisting of titanium (Ti), vanadium (V), chromium (Cr), and manganese (Mn) and wherein the ferromagnetic thin film of iron is alloyed with the element to reduce the relaxation rate of the ferromagnetic thin film;
a dielectric layer formed on at least a portion of the ferromagnetic thin film; and
a second electrode layer formed on the dielectric layer, wherein the filter tunes out a given range of frequencies corresponding to a magnetic field that is applied to the ferromagnetic thin film.

25. The filter of claim 24, wherein the element is vanadium, thereby forming an alloy of Fe₁₋ₓVₓ, wherein x is between about 0.01 and about 0.33.

26. The filter of claim 24, wherein the ferromagnetic thin film is formed by sputtering iron and the element onto the first electrode layer.

27. A tunable filter in a device, the filter comprising:
a substrate;
a first electrode layer formed on the substrate;
a ferromagnetic thin film formed on the first electrode layer, wherein:
the ferromagnetic thin film is composed of an alloy of (a) iron and (b) an element selected from the group consisting of titanium (Ti), vanadium (V), chromium (Cr), and manganese (Mn);
the ferromagnetic thin film of iron is alloyed with the element to reduce the relaxation rate of the ferromagnetic thin film; and
the ferromagnetic thin film is tunable to a desired frequency by applying a magnetic field;
a dielectric layer formed on at least a portion of the ferromagnetic thin film; and
a second electrode layer formed on the dielectric layer, wherein the filter tunes out a given range of frequencies corresponding to a magnetic field that is applied to the ferromagnetic thin film.

28. The filter of claim 27, wherein the device is a radio frequency identification tag.

29. A method of decreasing the relaxation rate of a magnetic material, the method comprising:
providing a substrate; and
forming a ferromagnetic thin film on the substrate, wherein the thin film is composed of iron having a relaxation rate that is alloyed with an amount of a lower valence transition metal element to decrease the relaxation rate of iron.
